(19) United States
(12) Patent Application Publication
(10) Pub. No.: US 2009/0257146 A1
(43) Pub. Date: Oct. 15, 2009

(54) MAGNETIC DISC APPARATUS AND TRACK FOLLOWING METHOD

(75) Inventor: Hiroyuki Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/489,134

(22) Filed: Jun. 22, 2009

Related U.S. Application Data
(63) Continuation of application No. PCT/JP2007/050330, filed on Jan. 12, 2007.

(51) Int. Cl. G11B 21/02

(52) U.S. Cl. 360/75; G9B/21.003

(57) ABSTRACT

A disclosed magnetic disc apparatus includes a magnetic disc medium including a first part and a second part having light reflection different from light reflection of the first part; a head having a first device for detecting reflectivity on the magnetic disc medium and a second device for performing magnetic recording/playback on the magnetic disc medium; and a positioning unit configured to determine, based on the reflectivity on the magnetic disc medium detected by the first device, a position for the magnetic recording/playback performed by the second device on the magnetic disc medium.

### CROSS-REFERENCE TO RELATED APPLICATIONS

The present application is a continuation application filed under 35 U.S.C. 111(a) claiming benefit under 35 U.S.C. 120 and 365(c) of PCT International Application No. PCT/JP2007/050330, filed on Jan. 12, 2007, the entire contents of which are incorporated herein by reference.

### FIELD

The present disclosure is directed to a magnetic disc apparatus, a magnetic disc medium, a head and a track following method, and in particular to a technology for causing a head to follow tracks on a discrete medium or a patterned medium with high accuracy.

### BACKGROUND

In recent years, the size reduction and capacity increase of magnetic disc apparatuses have been achieved at a rapid pace, and in accordance with this trend, increases in areal density of magnetic disc media have been promoted. In magnetic disc media having high densities, the space between adjacent data tracks is small, which results in problems including magnetic influences from neighboring tracks and thermal fluctuation.

Discrete media and patterned media have been proposed as media capable of preventing such magnetic influences from neighboring tracks and thermal fluctuation in spite of increases in the densities (see Japanese Laid-open Patent Application Publication No. 2004-227654).

As for a discrete medium, interference from neighboring data tracks is reduced by forming grooves between data tracks of the medium body or forming data tracks in grooves of the medium body, thereby increasing the track density. As for a patterned medium, interference between adjacent bits is reduced by forming tiny holes (nano-pores) on the medium body and depositing magnetic particles in the nano-pores (called “patterned bits”), thereby increasing the recording density.

On the other hand, along with the density increases of magnetic disc media, it is necessary to cause heads for magnetic recording and playback processes to follow data tracks with high accuracy. Various methods to cause a head to follow data tracks of a magnetic disc medium have been proposed, and one of such is that a mechanism capable of positioning a head using light is provided and the head positioning is controlled using an optical pickup (Japanese Laid-open Patent Application Publication No. 2001-056744).

The magnetic disc media described above are manufactured by conducting a nano-imprint technique using a master on which tracks are defined in advance. FIGS. 1A through 1C show a manufacturing method of a magnetic disc medium 3 using a nano-imprint technique. FIG. 1A illustrates a master 1 (stamper). On the master 1, a pattern 2 corresponding to a track pattern to be formed on the magnetic disc medium 3 using electron lithography or the like is provided.

The master 1 is pressed on the magnetic disc medium 3, as illustrated in FIG. 1B, whereby the pattern 2 on the master 1 is transferred to the magnetic disc medium 3. Subsequently, a process of forming a magnetic film or the like is performed, and in this manner, the magnetic disc medium 3 having predetermined tracks 4 (or patterned bits) as illustrated in FIG. 1C is manufactured. By employing this technique, it is possible to readily manufacture a magnetic disc medium having fine data tracks or patterned bits at high productivity.

However, in the above method of transferring the pattern 2 of the master 1 by pressing the master 1 on the magnetic disc medium 3, tracks distorted from a perfect circle can be formed on the manufactured magnetic disc medium 3.

FIGS. 2A through 2C illustrate distortion occurring on a servo/data track separated system magnetic disc medium 3A (for the sake of simplicity, the distortion is illustrated with exaggeration). In the servo/data track separated system magnetic disc medium 3A, servo tracks 5 are isolated from data tracks 6, and position information (servo information) is, therefore, obtained in a continuous manner.

FIGS. 3A through 3C illustrate distortion on a sector servo system magnetic disc medium 3B (in these diagrams also, the distortion is illustrated with exaggeration). In the sector servo system magnetic disc medium 3B, parts of servo/data mixed tracks 8 are used as servo sectors 7, and therefore, position information (servo information) cannot be obtained in a continuous manner, unlike the servo/data track separated system.

In either the servo/data track separated system magnetic disc medium 3A or the sector servo system magnetic disc medium 3B, if distortion occurs as described above, the servo tracks 5 or the servo sectors 7 on the medium body are displaced from their proper positions. This prevents a head from following the data tracks 6 or the servo/data mixed tracks 8 with high accuracy.

In particular, in the sector servo system magnetic disc medium 3B (FIGS. 3A through 3C) in which the servo sectors 7 are provided in a radial fashion, servo information exists in one track in a discrete manner. Accordingly, according to this system, positioning information is obtained intermittently and the sampling is performed in a discrete manner. As a result, it is more difficult to cause the head to follow tracks having distortion (especially, a high-order component) with high accuracy compared to the servo/data track separated system.

In the case of patterned media, it is necessary to accurately detect positions of patterned bits in the circumferential direction in order to perform write/read operations. However, if distortion occurs as described above, displacement may occur in positions at which patterned bits are formed. In such a case, accurate magnetic recording/playback may not be performed.

On the other hand, displacement of the data tracks 6 and the servo/data mixed tracks 8 due to distortion may be compensated by improving the head performance of following the tracks 6 and 8. Japanese Laid-open Patent Application Publication No. 2001-056744 discloses such a technique, and positions of the individual tracks 6 and 8 are detected using light.

The technique disclosed in Japanese Laid-open Patent Application Publication No. 2001-056744 is a so-called dedicated servo system, in which servo information (positioning information) is recorded intensively in one of multiple discs provided, and head positioning is performed by reading the servo information by an optical head. According to the technique, one or more magnetic disc media on which data are recorded and an optical disc medium on which position information is recorded are separately provided.

Accordingly, the above-mentioned distortion could occur on the magnetic disc media independently of the optical disc medium. Therefore, it is not possible to cause the head to accurately follow data tracks having distortion by performing positioning of the head based on the optical disc medium. Thus, the conventional techniques leave the problem that in the case of having distortion on a magnetic disc medium, it is not possible to cause the head to follow the data tracks with high accuracy.

### SUMMARY

One aspect of the present disclosure is a magnetic disc apparatus including a magnetic disc medium that includes a first part and a second part having light reflection different from light reflection of the first part; a head having a first device for detecting reflectivity on the magnetic disc medium and a second device for performing magnetic recording/playback on the magnetic disc medium; and a positioning unit configured to determine, based on the reflectivity on the magnetic disc medium detected by the first device, a position for the magnetic recording/playback performed by the second device on the magnetic disc medium.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A shows a master used in nano-imprint technology;

FIG. 1B shows a nano-imprint process;

FIG. 1C shows a magnetic disc medium manufactured using nano-imprint technology;

FIG. 2A shows a servo/data track separated system magnetic disc medium;

FIG. 2B is an enlarged view of a part indicated by arrow A in FIG. 2A;

FIG. 2C illustrates distortion of tracks on the servo/data track separated system magnetic disc medium;

FIG. 3A shows a sector servo system magnetic disc medium;

FIG. 3B is an enlarged view of a part indicated by arrow B in FIG. 3A;

FIG. 3C illustrates distortion of tracks on the sector servo system magnetic disc medium;

FIG. 4 shows a structure of a magnetic disc apparatus according to one embodiment of the present disclosure;

FIG. 5 is a perspective view of a suspension arm having a head of one embodiment of the present disclosure;

FIG. 6 is a perspective view showing a head according to the first embodiment of the present disclosure;

FIG. 7 shows a structure of a photodetector;

FIG. 8 shows a magnetic disc medium (a discrete system and servo/data track separated system medium) according to the first embodiment of the present disclosure;

FIG. 9 is an enlarged view of a part indicated by arrow A in FIG. 8;

FIG. 10A relates to a method of manufacturing the magnetic disc medium of the first embodiment, and shows a resist coating process;

FIG. 10B relates to the method of manufacturing the magnetic disc medium of the first embodiment, and shows a groove forming process;

FIG. 10C relates to the method of manufacturing the magnetic disc medium of the first embodiment, and shows an etching process on a medium body;

FIG. 10D relates to the method of manufacturing the magnetic disc medium of the first embodiment, and shows a magnetic film forming process;

FIG. 10E relates to the method of manufacturing the magnetic disc medium of the first embodiment, and shows a lift-off process;

FIG. 11A relates to a method of manufacturing a magnetic disc medium of the second embodiment, and shows a magnetic film forming process;

FIG. 11B relates to the method of manufacturing the magnetic disc medium of the second embodiment, and shows a resist coating process;

FIG. 11C relates to the method of manufacturing the magnetic disc medium of the second embodiment, and shows a groove forming process;

FIG. 11D relates to the method of manufacturing the magnetic disc medium of the second embodiment, and shows an etching process on a medium body;

FIG. 11E relates to the method of manufacturing the magnetic disc medium of the second embodiment, and shows a resist removing process;

FIG. 12 illustrates a track following method of the first embodiment of the present disclosure;

FIG. 13A shows a state where track displacement is absent in the first embodiment;

FIG. 13B shows a state where track displacement is present in the first embodiment;

FIG. 14 is a flowchart of the track following method of the first embodiment of the present disclosure;

FIG. 15 shows a magnetic disc medium (a discrete system and sector servo system medium) according to the second embodiment of the present disclosure;

FIG. 16 is an enlarged view of a part indicated by arrow B in FIG. 15;

FIG. 17 illustrates a track following method of the second embodiment of the present disclosure;

FIG. 18A shows a state where track displacement is absent in the second embodiment;

FIG. 18B shows a state where track displacement is present in the second embodiment;

FIG. 19 is a flowchart of the track following method of the second embodiment of the present disclosure;

FIG. 20 shows a magnetic disc medium (a patterned medium system and servo/data track separated system medium) according to a third embodiment of the present disclosure;

FIG. 21 illustrates a track following method of the third embodiment of the present disclosure;

FIG. 22 is a timing chart illustrating timing of a recording/playback process performed on a magnetic disc medium according to the third embodiment of the present disclosure; and

FIG. 23 is a flowchart of the track following method of the third embodiment of the present disclosure.

### DESCRIPTION OF EMBODIMENTS

Next are described embodiments of the present disclosure with reference to the drawings.

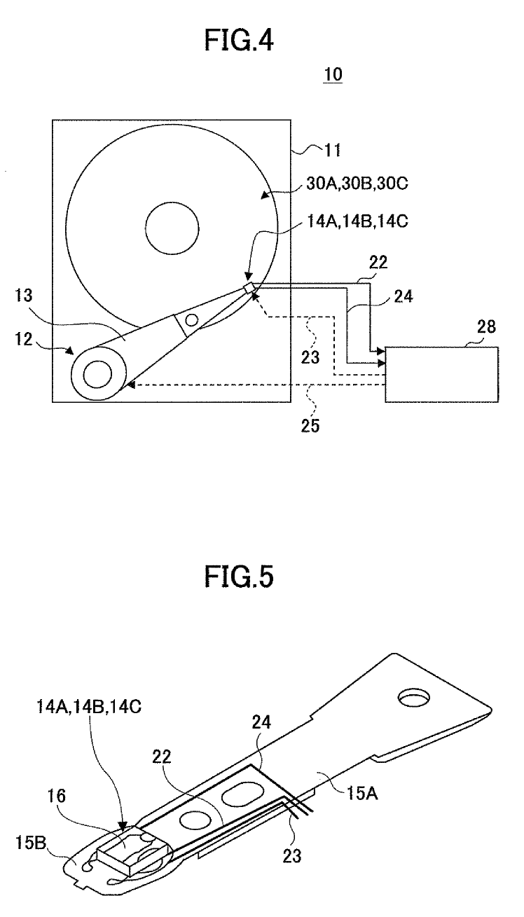

FIG. 4 shows a schematic structure of a magnetic disc apparatus 10 according to the first embodiment of the present disclosure. As illustrated in FIG. 4, the magnetic disc apparatus 10 includes a housing 11, a magnetic disc medium (any one of magnetic disc media 30A through 30C to be described below), a head (any one of heads 14A through 14C to be described below), a voice coil motor (VCM) 12, a control apparatus 28 and the like.

The head 14A, 14B or 14C is provided at the tip of a suspension arm 15A, as shown in FIG. 5 in close-up. Specifically, a gimbal spring 15B is provided at the tip of the suspension arm 15A, and the head 14A, 14B or 14C is disposed on top of the gimbal spring 15B.

The suspension arm 15A is fixed on an arm 13 connected to the VCM 12. The VCM 12 is a motor that generates a driving force for moving the head 14A, 14B or 14C to a predetermined position on the magnetic disc medium 30A, 30B or 30C.

The VCM 12 is drive-controlled by the control apparatus 28. Therefore, when the control apparatus 28 drives the VCM 12, the arm 13 (suspension arm 15A) pivots, whereby the head 14A, 14B or 14C moves to a predetermined position on the magnetic disc medium 30A, 30B or 30C.

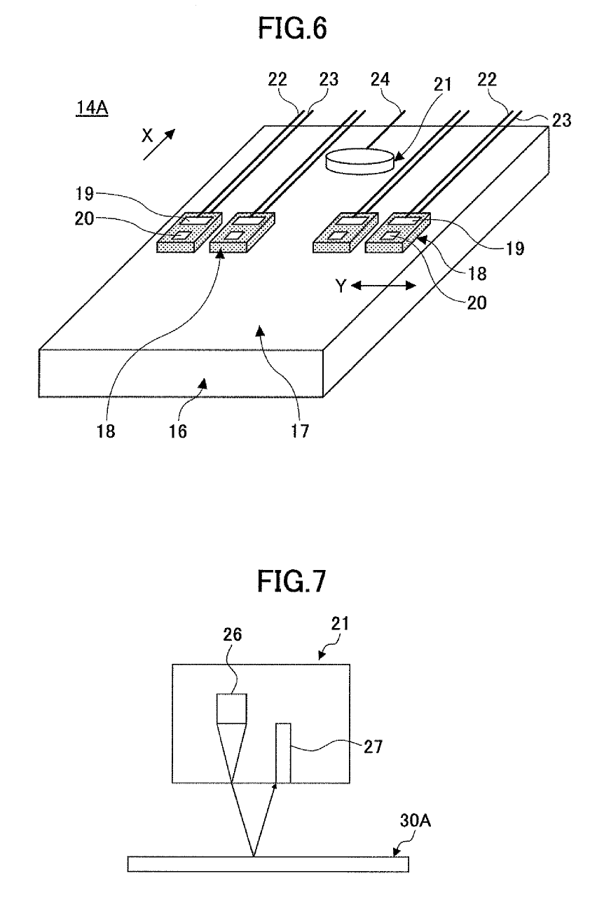

FIG. 6 shows the head 14A of the first embodiment of the present disclosure.

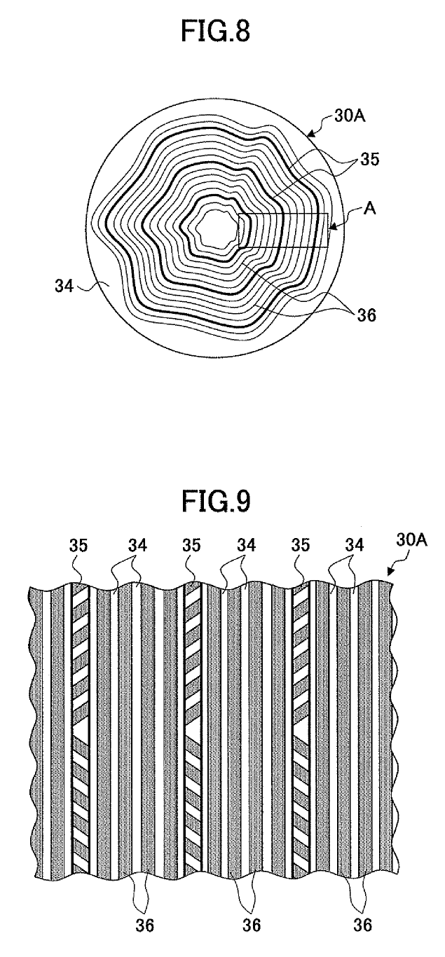

The head 14A is used to perform magnetic recording and playback processes on a servo/data track separated system magnetic disc medium 30A of FIGS. 8 and 9. The head 14A generally includes a slider 16, second sliders 18, write devices 19, read devices 20, a photodetector 21 and the like.

The slider 16 is made of, for example, a nonmagnetic material, such as ceramic. The slider 16 includes a first slider 17 and the second sliders 18. The first slider 17 functions as a substrate on which various devices 19, 20 and 24 to be described later are mounted.

The head 14A is a so-called floating head, and floats a minute distance above the surface of the magnetic disc medium 30A to perform the magnetic recording and playback processes. Grooves and projections (not shown) to cause the head 14A to float are formed on the slider 16.

The second sliders 18 are disposed on the first slider 17. Each second slider 18 is a piezoelectric element, on which the write device 19 and the read device 20 are mounted. Accordingly, the write device 19 and the read device 20 can be shifted in a direction indicated by arrow Y in FIG. 6 (i.e. a direction perpendicular to a relative moving direction (indicated by arrow X in FIG. 6) of the head 14A) when the second slider 18 being a piezoelectric element is driven.

Multiple second sliders 18 (four in the case of the present embodiment) are provided on the first slider 17. The second sliders 18 are provided in such a manner as to correspond to the pitch of data tracks 36 on the magnetic disc medium 30A.

The write devices 19 are employed to perform a recording process on the magnetic disc medium 30A, and the present embodiment adopts perpendicular-magnetic-recording thin film heads as the write devices 19. The read devices 20 are employed to perform a process of reading signals recorded on the magnetic disc medium 30A, and the present embodiment adopts MR heads (magnetoresistance effect heads) as the read devices 20.

The photodetector 21 is provided in the middle of the four second sliders 18 in such a manner that two of the second sliders 18 are positioned on either side of the photodetector 21. The photodetector 21 includes a light emitting device 26 and a light receiving device 27, as shown in FIG. 7 in close-up.

The light emitting device 26 emits a spot light 44 toward the magnetic disc medium 30A. The spot light 44 is reflected by the servo track 35 of the magnetic disc medium 30A, and the reflected light is then received by the light receiving device 27, as described later. As the light receiving device 27, a device capable of detecting the light intensity of the reflected light is used.

A photodetector wire 24 is led out from the photodetector 21. A driving wire 23 is led out from each second slider 18. A recording/playback wire 22 is led out from the write device 19 and the read device 20 disposed on each second slider 18. The individual wires 22 through 24 are connected to the control apparatus 28. The control apparatus 28 is connected to the VCM 12 by a VCM wire 25, and the VCM 12 is drive-controlled by the control apparatus 28, as described above.

FIGS. 8 and 9 show the magnetic disc medium 30A according to the first embodiment. The magnetic disc medium 30A is compliant to the head 14A of FIG. 6, as described above, and therefore, in the case where the magnetic disc medium 30A is applied to the magnetic disc apparatus 10 (see FIG. 4), the head 14A of FIG. 6 is used.

The magnetic disc medium 30A is a discrete system and servo/data track separated system medium. The magnetic disc medium 30A, which is a discrete medium, has a structure in which grooves are formed between individual data tracks on the medium body 34, or data tracks are formed in grooves on the medium body 34, thereby reducing interference between each data track and increasing the track density.

Since the magnetic disc medium 30A is also a servo/data track separated system medium, the servo tracks 35 are isolated from the data tracks 36. Therefore, according to the magnetic disc medium 30A of the present embodiment, position information (servo information) of the head 14A can be obtained in a continuous manner using the servo tracks 35.

Next is described the structure of the magnetic disc medium 30A. The magnetic disc medium 30A has a structure in which the servo tracks 35 and the data tracks 36 are formed on the medium body 34.

In the present embodiment, the medium body 34 (corresponding to the “second part” defined in the appended claims) is made of silicon, which is a low reflecting material. On the other hand, the servo tracks 35 and the data tracks 36 (the “first part”) are formed of an iron or cobalt-system magnetic film.

The magnetic film has high reflectivity compared to silicon. That is, the magnetic disc medium 30A of the present embodiment includes the medium body 34 and the individual tracks 35 and 36 exhibiting different reflectivities when light is incident thereon. Note that as long as the medium body 34 and the individual tracks 35 and 36 have different light reflectivities, their materials are not limited to the above.

Next is described a method of manufacturing the magnetic disc medium 30A which includes two parts having different reflectivities when light is incident thereon.

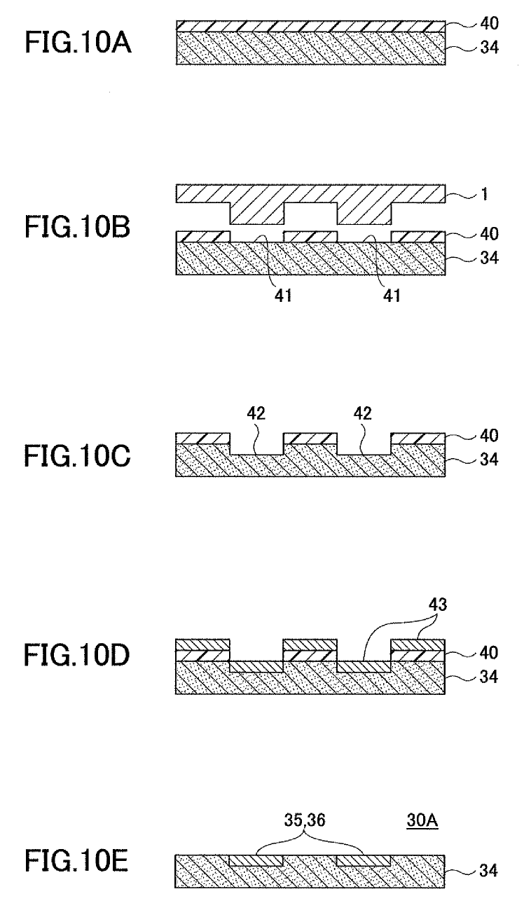

FIGS. 10A through 10E show the method of manufacturing the magnetic disc medium 30A according to the first embodiment. In the manufacturing method of the present embodiment, the individual tracks 35 and 36 are formed in grooves 42 on the medium body 34.

For manufacturing the magnetic disc medium 30A, the medium body 34 made of silicon, which is a low reflecting material, is first provided. On the disc-shaped medium body 34, first, a resist 40 is formed (FIG. 10A). The formation of the resist 40 is performed by, for example, a spin coat method.

Subsequently, using nano-imprint technology, the master 1 is pressed on the resist 40, thereby forming a pattern 41 on the resist 40 (FIG. 10B). Herewith, the pattern of the master 1 is transferred to the resist 40. The above-described distortion occurs when the pattern of the master 1 is transferred to the resist 40.

Next, etching is performed on the medium body 34, using the resist 40 as a mask, and the grooves 42 are formed on the medium body (FIG. 10C). A magnetic film 43 is formed over the entire upper surface of the medium body 34 (FIG. 10D). The formation of the magnetic film 43 is performed by, for example, sputtering. The magnetic film 43 may be made of an iron or cobalt-system magnetic material having a different reflectivity from that of the medium body 34.

After the process of forming the magnetic film 43 is completed, unnecessary magnetic film 43 is removed by lift-off together with the resist 40. In this manner, the magnetic disc medium 30A having the servo tracks 35 and the data tracks 36 formed in the grooves 42 on the medium body 34 is manufactured.

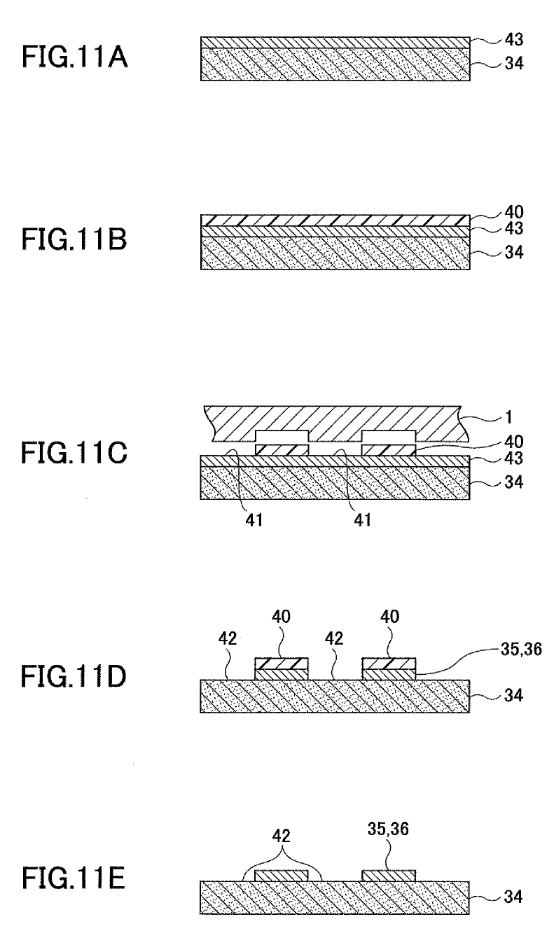

On the other hand, FIGS. 11A through 11E show a method of manufacturing the magnetic disc medium 30A according to the second embodiment. According to the manufacturing method of the present embodiment, the magnetic disc medium 30A in which the grooves 42 are formed between the individual tracks 35 and 36 on the medium body 34 is manufactured.

For manufacturing the magnetic disc medium 30A having such a structure, the disc-shaped medium body 34 made of silicon, which is a low reflecting material, is first provided. On the entire upper surface of the medium body 34, the magnetic film 43 is formed (FIG. 11A). The formation of the magnetic film 43 is performed by, for example, sputtering. The magnetic film 43 may be made of an iron or cobalt-system magnetic material having a different reflectivity from that of the medium body 34.

Subsequently, the resist 40 is formed over the entire upper surface of the magnetic film 43 (FIG. 11B). The formation of the resist 40 is performed by, for example, a spin coat method.

Then, using nano-imprint technology, the master 1 is pressed on the resist 40, thereby forming the pattern 41 on the resist 40 (FIG. 11C). Herewith, the pattern of the master 1 is transferred to the resist 40. In the present embodiment also, distortion occurs when the pattern of the master 1 is transferred to the resist 40.

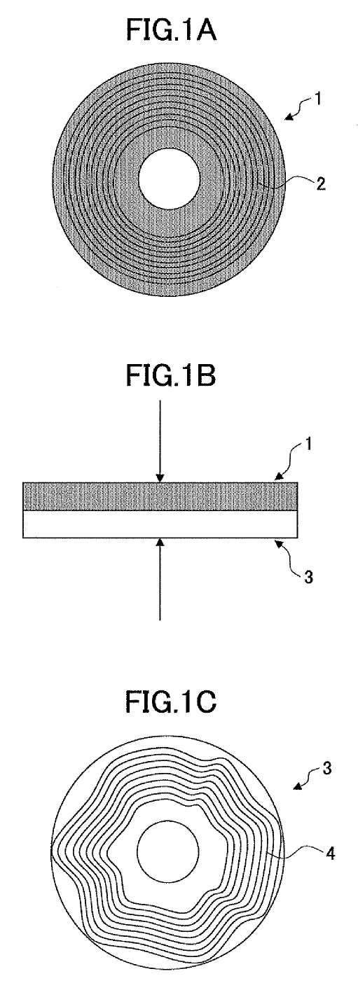

Next, etching is performed on the magnetic film 43, using the resist 40 as a mask. Accordingly, the servo tracks 35 and the data tracks 36 are formed and the grooves 42 are also formed between adjacent tracks 35 and 36 (FIG. 1D). Then, the resist 40 is removed, whereby the magnetic disc medium 30A having the grooves 42 between adjacent tracks 35 and 36 on the medium body 34 is manufactured. The head 14A of FIG. 4 is applicable to the magnetic disc medium 30A manufactured by the method according to either of the first or second embodiment.

Next is described a track following control process carried out when the magnetic recording/playback process is performed on the above-described magnetic disc medium 30A using the head 14A. The track following control process is a positioning control process (servo control process) in which the position of the head 14A on the magnetic disc medium 30A is detected, and a correction is made if there is displacement from its proper position.

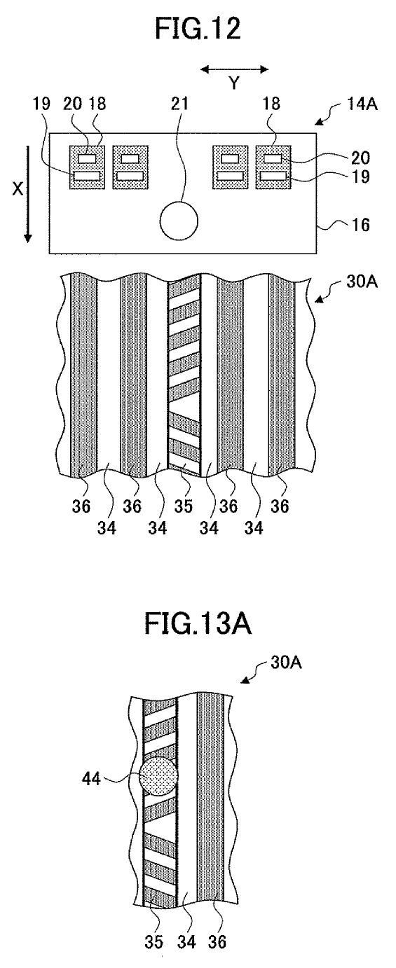

FIG. 12 shows that the magnetic recording/playback process is being performed on the magnetic disc medium 30A using the head 14A. In FIG. 12, the head 14A moves in the direction of arrow X relative to the magnetic disc medium 30A.

When the head 14A moves in the X direction relative to the magnetic disc medium 30A, the photodetector 21 (the “first device” defined in the appended claims) emits the spot light 44 toward a servo track 35 of the magnetic disc medium 30A. Note that the photodetector 21 is provided anterior to the write and read devices 19 and 20 (the “second device”) in the traveling direction of the head 14A, as shown in FIG. 12.

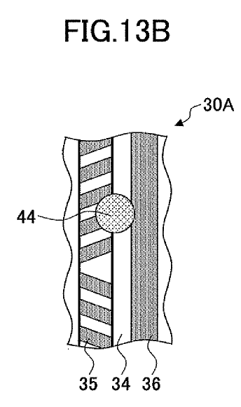

FIG. 13A shows the case in which the head 14A is properly positioned in relation to the magnetic disc medium 30A. In the proper condition, the spot light 44 emitted from the photodetector 21 is incident at the center (the center position in the track width direction) of the servo track 35. When the head 14A is located at the proper position, the write devices 19 and the read devices 20 oppose the data tracks 36 in an optimum condition, whereby it is possible to favorably perform the magnetic recording/playback process.

As described above, the surface (recording/playback surface) of the magnetic disc medium 30A includes parts at which the individual tracks 35 and 36 having high reflectivity are provided and parts at which the medium body 34 having reflectivity lower than that of the individual tracks 35 and 36 is exposed. Accordingly, as illustrated in FIG. 13B, if the head 14A is displaced in relation to the magnetic disc medium 30A and the spot light 44 is out of the center position of the servo track 35, the spot light 44 is incident also on the medium body 34 having low reflectivity.

Therefore, if the spot light 44 is out of the servo track 35, the amount of the light reflected by the magnetic disc medium 30A is reduced. A decrease in the amount of the reflected light correlates with the amount of displacement of the spot light 44 from the servo track 35, in other words, correlates with the amount of displacement from the proper position of the head 14A.

A decrease in the amount of the reflected light is detected by the light receiving device 27 of the photodetector 21. Then, a signal (hereinafter, referred to as “position signal”) corresponding to the amount of displacement detected by the photodetector 21 is sent to the control apparatus 28.

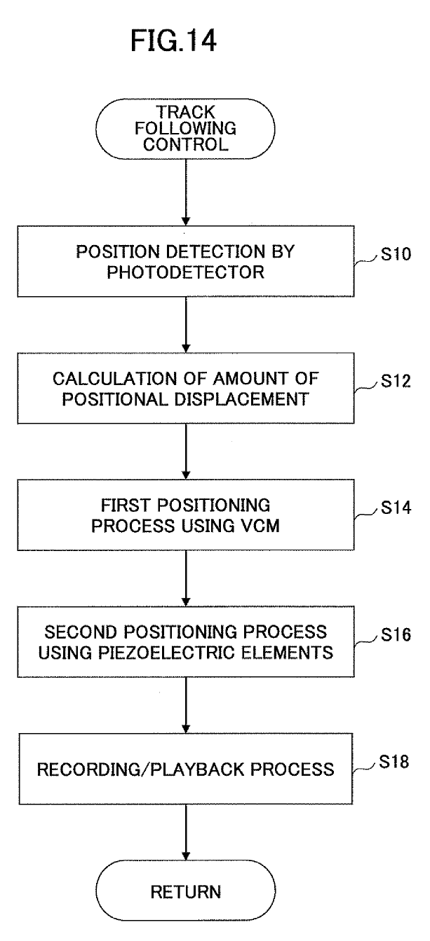

Next is described track following control performed by the control apparatus 28. FIG. 14 is a flowchart illustrating the track following control process performed by the control apparatus 28.

When the process illustrated in FIG. 14 is started, first in Step S10, the control apparatus 28 detects the position of the head 14A based on the position signal sent from the photodetector 21. Next in Step S12, the control apparatus 28 calculates the amount of displacement of the head 14A from its proper position (the position illustrated in FIG. 13A) based on the position of the head 14A obtained in Step S10.

Next in Step S14, the control apparatus 28 determines whether the amount of displacement calculated in Step S12 is equal to or more than the length that the piezoelectric elements serving as the second sliders 18 are able to shift the write/read devices 19/20. If the amount of displacement of the head 14A exceeds the amount that can be shifted by the piezoelectric elements, the control apparatus 28 drives the VCM 12 to move the head 14A to its proper position.

If the amount of displacement calculated in Step S12 is less than the amount that can be shifted by the piezoelectric elements, in Step S16, the control apparatus 28 shifts the write/read devices 19/20 to their adequate positions using the second sliders 18 formed of piezoelectric elements. According to the above processes in Steps S14 and S16, the write/read devices 19/20 become aligned to the data tracks 36. As a result, in Step S18, the write/read devices 19/20 are able to favorably perform the magnetic recording/playback process on the data tracks 36.

In the present embodiment, as described above, the head 14A has a structure in which the photodetector 21 dedicated to follow the servo track 35 and the write/read devices 19/20 for performing the magnetic recording/playback process on the data tracks 36 are disposed in accordance with the track pitches. Using such a head 14A, the magnetic recording/playback process is performed on the data tracks 36 while the position of the head 14A is being corrected based on the intensity of the reflected light detected by the photodetector 21.

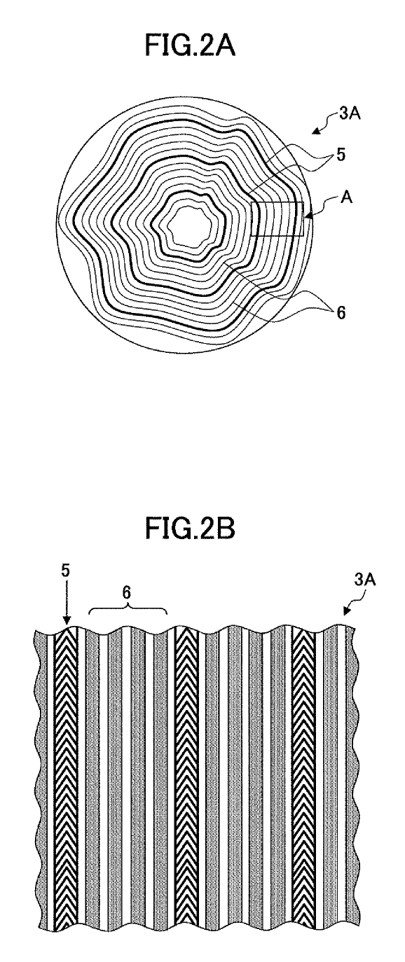

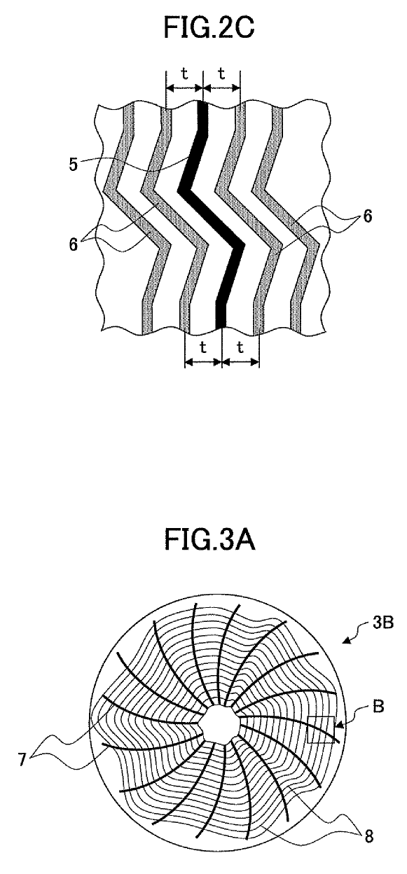

At this point, even if track distortion is present in the servo tracks 35 and the data tracks 36 on the magnetic disc medium 30A due to the above described reason, the tracks 35 and 36 maintain similar regularity (see FIG. 2C, all “t”s are equal). Therefore, the positioning accuracy on the data tracks 36 is compensated. In addition, the write/read devices 19/20 are finely adjustable in the cross track direction (Y direction) by the second sliders 18 formed of piezoelectric elements, thereby being able to compensate track pitch displacement with higher accuracy.

In the case of the discrete system magnetic disc medium 30A on which the individual tracks 35 and 36 are densely formed, the track pitch is narrow. Therefore, when the position signal is magnetically read from the servo track 35, magnetic influence from adjacent tracks may arise, which results in a decrease in the accuracy of the position information. However, this problem is eliminated by optically detecting the servo track 35, allowing positioning with high accuracy.

Since the servo tracks 35 are isolated from the data tracks 36, the photodetector 21 (head 14A) is able to obtain the position information of the head 14A in a continuous manner using the servo tracks 35. As a result, it is possible to follow high-order skew (large distortion), and it is also possible to avoid limitation of discrete sampling of the position information, thereby being able to follow the track distortion with high accuracy.

In addition, regarding the off-track amount of the servo track 35, a pattern (a phase pattern indicated by diagonal lines in the figures) which is recorded in the servo tracks 35 is detected. Herewith, according to the amount of reflection from the phase pattern, the off-track amount can be detected, thereby enabling further accurate positioning.

Next is described a magnetic disc apparatus according to the second embodiment of the present disclosure.

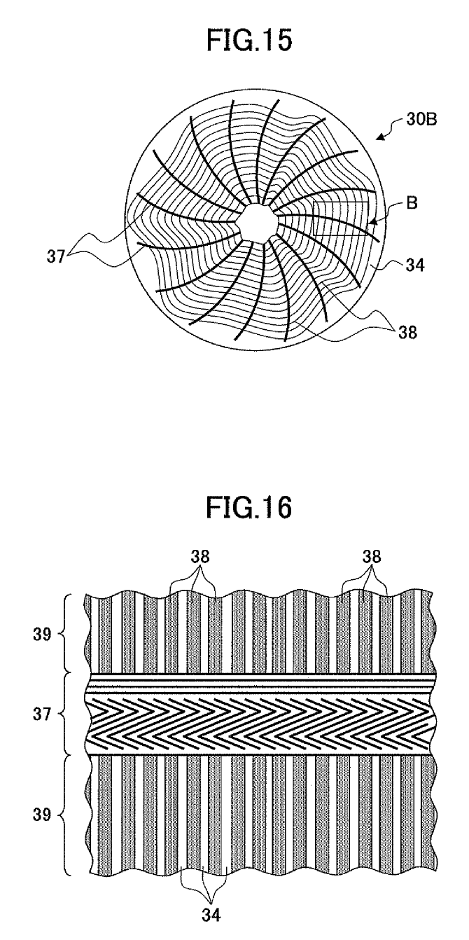

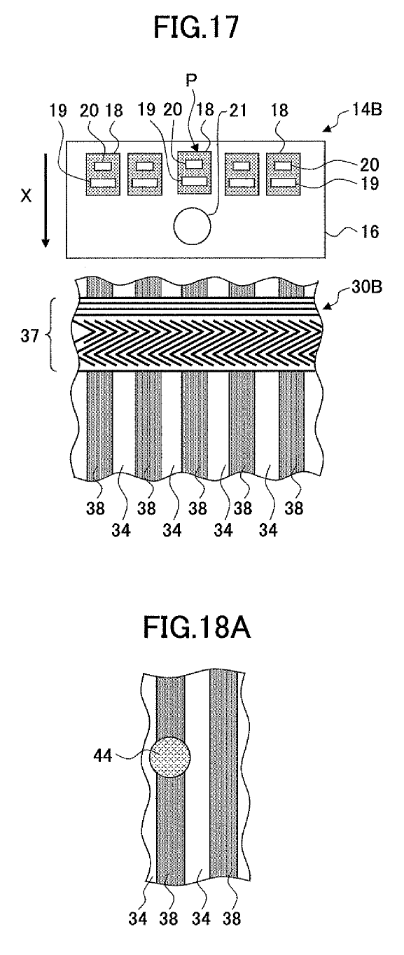

The magnetic disc apparatus according to the present embodiment is characterized by using a magnetic disc medium 30B illustrated in FIGS. 15 and 16 and a head 14B illustrated in FIG. 17. Note that in the following explanation and figures referred to in the explanation, the same reference numerals are given to the components which are common to those of FIGS. 4 through 14, and their explanations are omitted.

The magnetic disc medium 30B used in the present embodiment is a discrete system and sector servo system medium. In the magnetic disc medium 30B, parts of servo/data mixed tracks 38 are used as servo sectors 37, as shown in FIG. 16 in close-up.

Therefore, unlike the servo/data track separated system magnetic disc medium 30A of the first embodiment described above, the position information (servo information) cannot be obtained in a continuous manner. Track distortion also occurs in the magnetic disc medium 30B, as in the case of the magnetic disc medium 30A (see FIG. 15).

Also in the present embodiment, the medium body 34 is made of silicon, which is a low reflecting member, and the servo/data mixed tracks 38 are formed of a magnetic film having reflectivity different from that of silicon. Thus, the magnetic disc medium 30B also includes the medium body 34 and the servo/data mixed tracks 38 having different reflectivities when light is incident thereon.

The head 14B of the present embodiment generally has the same structure as that of the head 14A of the first embodiment. However, the head 14A does not have a second slider 18 corresponding to a track line (line in the X direction), along which the photodetector 21 follows. On the other hand, as illustrated in FIG. 17, in the head 14B of the present embodiment, a second slider 18 (indicated by arrow P in FIG. 17) is provided also on the track line, along which the photodetector 21 follows.

Next is described a track following control process carried out when the magnetic recording/playback process is performed on the above-described magnetic disc medium 30B using the head 14B.

FIG. 17 shows that the magnetic recording/playback process is being performed on the magnetic disc medium 30B using the head 14B. In FIG. 17, the head 14B moves in the direction of arrow X relative to the magnetic disc medium 30B.

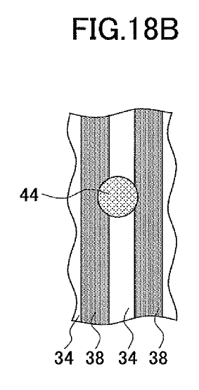

When the head 14B moves in the X direction relative to the magnetic disc medium 30B, the photodetector 21 of the present embodiment emits the spot light 44 toward a servo/data mixed track 38 of the magnetic disc medium 30B. FIG. 18A shows that the head 14B is properly positioned in relation to the magnetic disc medium 30B.

In the proper condition, the spot light 44 emitted from the photodetector 21 is incident at the center (the center position in the track width direction) of the servo/data mixed track 38. When the head 14B is located at the proper position, the write devices 19 and the read devices 20 oppose the corresponding servo/data tracks 38 in an optimum condition, whereby it is possible to favorably perform the magnetic recording/playback process.

In this embodiment also, the surface of the magnetic disc medium 30B includes parts at which the servo/data mixed tracks 38 having high reflectivity are provided and parts at which the medium body 34 having reflectivity lower than that of the servo/data mixed tracks 38 is exposed. Accordingly, as illustrated in FIG. 18B, if the head 14B is displaced from its proper position in relation to the magnetic disc medium 30B and the spot light 44 is out of the center position of the servo/data mixed track 38, the spot light 44 is incident also on the medium body 34 having low reflectivity.

Therefore, if the spot light 44 is out of the servo/data mixed track 38, the amount of the light reflected by the magnetic disc medium 30B is reduced. A decrease in the amount of the reflected light correlates with the amount of displacement of the spot light 44 from the servo/data mixed track 38. Therefore, using the amount of displacement of the spot light 44, it is possible to obtain the amount of displacement of the head 14B from its proper position. A decrease in the amount of the reflected light is detected by the light receiving device 27 of the photodetector 21. Then, a position signal corresponding to the amount of displacement detected by the photodetector 21 is sent to the control apparatus 28.

In the case of the sector servo system magnetic disc medium 30B, along with the travel of the head 14B, the read devices 20 pass over the servo sectors 37 formed in the servo/data mixed tracks 38. Since the position information (servo information) is recorded in the servo sectors 37, the control apparatus 28 may also be able to detect the position of the head 14B according to the position information (servo information) transmitted from the read devices 20. The above-mentioned second slider 18 indicated by arrow P in FIG. 17 is provided so as to read the position information recorded in the servo sectors 37, which are provided in parts of the servo/data mixed tracks 38.

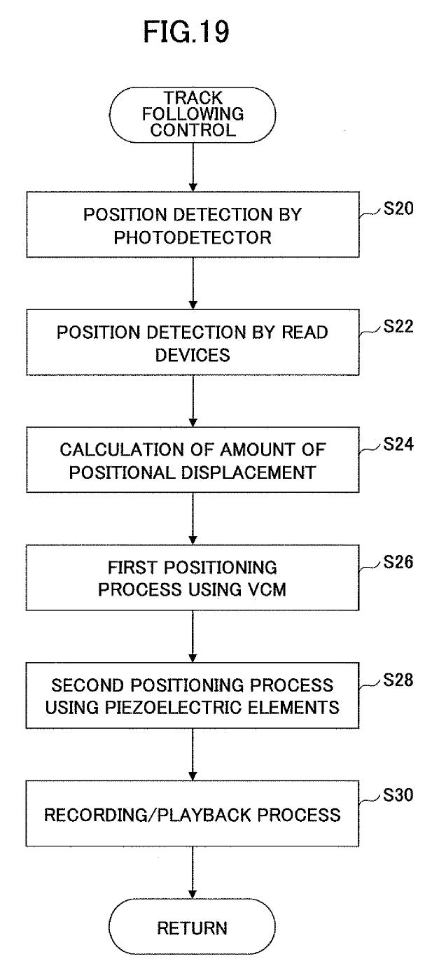

Next is explained track following control performed by the control apparatus 28 according to the present embodiment. FIG. 19 is a flowchart illustrating the track following control process performed by the control apparatus 28.

When the process illustrated in FIG. 19 is started, first in Step S20, the control apparatus 28 detects the position of the head 14B based on the position signal sent from the photodetector 21. Next in Step S22, the control apparatus 28 detects the position of the head 14B based on position information recorded in a servo sector 37 and transmitted by the individual read devices 20.

Next in Step S24, the control apparatus 28 calculates the amount of displacement of the head 14B from its proper position (the position illustrated in FIG. 18A) based on the position of the head 14B obtained in Steps S20 and 22.

Next in Step S26, based on the results of the position detection obtained mainly by the recording/playback wires 22, the control apparatus 28 performs a process of driving the VCM 12 to move the head 14B to its proper position so as to correct the positional displacement. Next in Step S28, based on the results of the position detection obtained mainly by the photodetector 21, the control apparatus 28 shifts the write/read devices 19/20 to their adequate positions using the second sliders 18 formed of piezoelectric elements.

According to the above processes in Steps S26 and S28, the write/read devices 19/20 become aligned to the servo/data mixed tracks 38. As a result, in Step S30, the write/read devices 19/20 are able to favorably perform the magnetic recording/playback process on the servo/data mixed tracks 38.

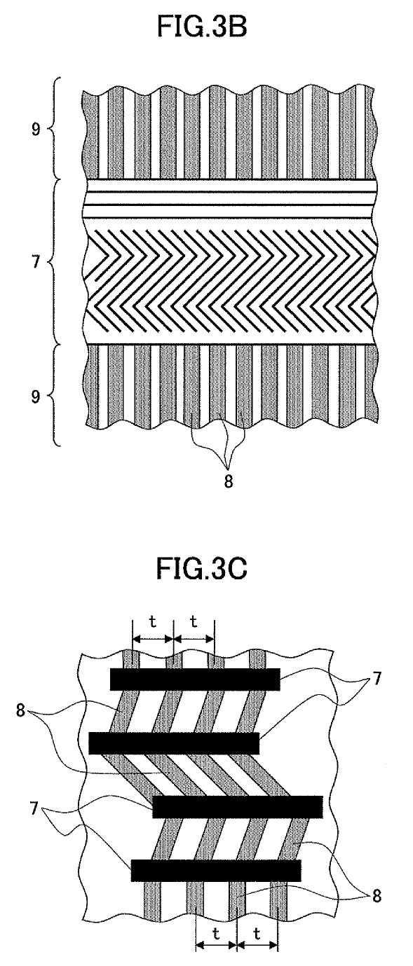

In the magnetic disc medium 30B of the present embodiment also, track distortion may be present in the servo/data mixed tracks 38. However, even if track distortion is present, the tracks 38 of the sector servo system maintain similar regularity (see FIG. 3C, all “t”s are equal). Therefore, the positioning accuracy on the servo/data mixed tracks 38 is compensated.

The present embodiment also has the following advantageous effects as in the case of the first embodiment: being able to compensate track pitch displacement with higher accuracy since the write/read devices 19/20 are finely adjustable in the cross track direction (Y direction) by the second sliders 18 formed of piezoelectric elements; and being able to eliminate the possibility of being magnetically influenced by adjacent tracks since the servo sectors 37 are optically detected, thereby enabling positioning with high accuracy.

Next is described a magnetic disc apparatus according to the third embodiment of the present disclosure.

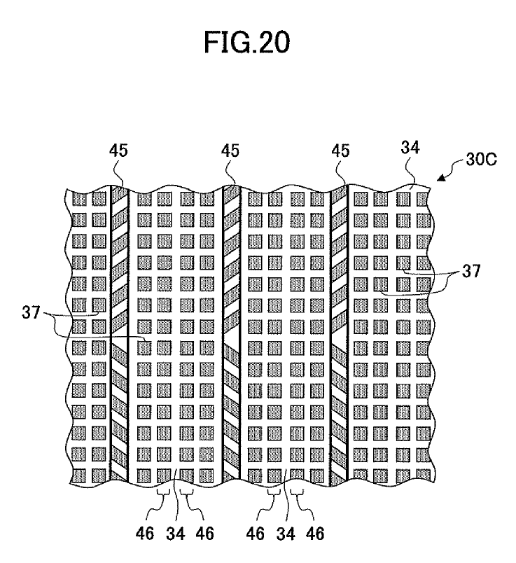

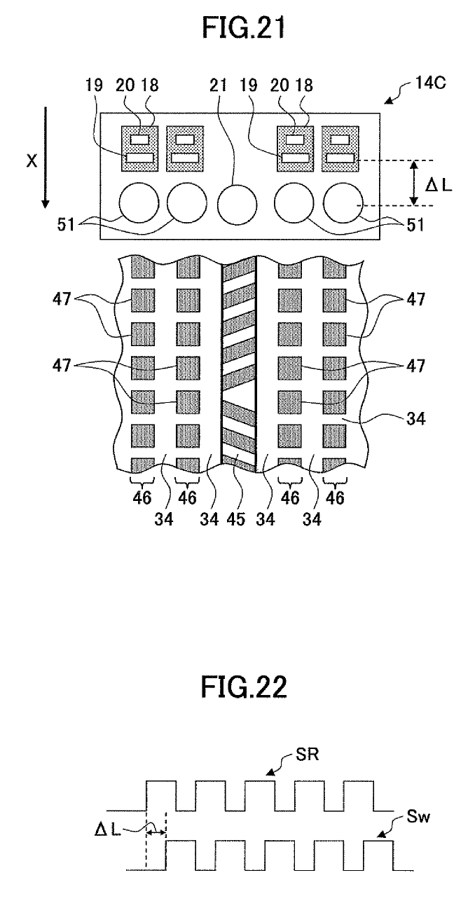

The magnetic disc apparatus according to the present embodiment is characterized by using a magnetic disc medium 30C illustrated in FIG. 20 and a head 14C illustrated in FIG. 21.

The magnetic disc medium 30C used in the present embodiment is a patterned medium system and servo/data track separated system medium. The magnetic disc medium 30C, which is a patterned medium, has a structure in which patterned bits 47 are provided by forming tiny holes (nano-pores) on the medium body 34 and depositing magnetic particles in the nano-pores. According to this structure, the individual patterned bits 47 are isolated, thereby reducing interference between adjacent patterned bits 47 and increasing the recording density. The patterned bits 47 are aligned in lines in the track direction so as to form data tracks 46.

The magnetic disc medium 30C is also a servo/data track separated system, and therefore, servo tracks 45 are isolated from data tracks 46. Accordingly, the magnetic disc medium 30C of the present embodiment is able to obtain position information (servo information) of the head 14C in a continuous manner using the servo tracks 45, as in the case of the magnetic disc medium 30A of the first embodiment.

As described above, the magnetic disc medium 30C has a structure in which the servo tracks 45 and the data tracks 46 are formed on the medium body 34. In the present embodiment also, the medium body 34 is made of silicon, which is a low reflecting material.

On the other hand, the servo tracks 45 and the data tracks 46 are formed of an iron or cobalt-system magnetic film having reflectivity higher than that of silicon. That is, the magnetic disc medium 30C of the present embodiment includes the medium body 34 and the individual tracks 45 and 46 having different reflectivities when light is incident thereon.

As illustrated in FIG. 21, the head 14C of the present embodiment has a structure similar to that of the head 14A of the first embodiment. However, in the case of the head 14A, photodetectors are not provided in such a manner as to correspond to track lines (lines in the X direction), along which the individual second sliders 18 follow. On the other hand, in the head 14C of the present embodiment, photodetectors 51 are provided so as to follow the track lines of the individual second sliders 18.

Next is described a track following control process carried out when the magnetic recording/playback process is performed on the above-described magnetic disc medium 30C using the head 14C.

FIG. 21 shows that the magnetic recording/playback process is being performed on the magnetic disc medium 30C using the head 14C. In FIG. 21, the head 14C moves in the direction of arrow X relative to the magnetic disc medium 30C.

When the head 14C moves in the X direction relative to the magnetic disc medium 30C, the photodetector 21 of the present embodiment emits the spot light 44 toward a servo track 45 of the magnetic disc medium 30C, and each photodetector 51 emits the spot light 44 toward a corresponding data track 46. As explained in the first embodiment, in the proper condition, the spot light 44 emitted from the photodetector 21 is incident at the center (the center position in the track width direction) of the servo track 45.

Also, the spot light 44 emitted from each photodetector 51 is incident at the center (the center position in the track width direction) of the corresponding data track 46. When the head 14C is located at its proper position, the write devices 19 and the read devices 20 oppose the pattern bits 47 of the data tracks 46 in an optimum condition. Herewith, the write/read devices 19/20 are able to favorably perform the magnetic recording/playback process with respect to the patterned bits 47.

In this embodiment also, the surface of the magnetic disc medium 30C includes parts at which the tracks 45 and 46 having high reflectivity are provided and parts at which the medium body 34 having reflectivity lower than that of the tracks 45 and 46 is exposed. Accordingly, if the head 14C is displaced from the proper position in relation to the magnetic disc medium 30C and each spot light 44 is out of the center position of a corresponding servo track 45 or data track 46, such spot lights 44 are incident also on the medium body 34 having low reflectivity.

Therefore, if the spot light 44 is out of the corresponding servo track 45 or data track 46, the amount of the light reflected by the magnetic disc medium 30C is reduced. A decrease in the amount of the reflected light correlates with the amount of displacement of the spot light 44 from the track 45 or 46. Therefore, using the amount of displacement of the spot light 44, it is possible to obtain the amount of displacement of the head 14C from its proper position. A decrease in the amount of the reflected light is detected by the light receiving device 27 of each photodetector 21 and 51. Then, a position signal corresponding to the amount of displacement detected by each photodetector 21 and 51 is sent to the control apparatus 28.

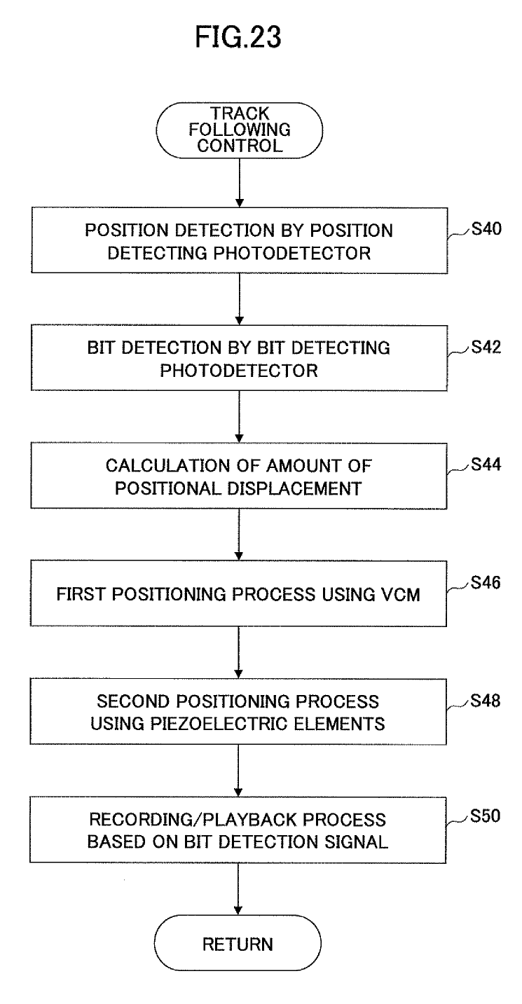

Next is explained track following control performed by the control apparatus 28 according to the present embodiment. FIG. 23 is a flowchart illustrating the track following control process performed by the control apparatus 28.

When the process illustrated in FIG. 23 is started, first in Step S40, the control apparatus 28 detects the position of the head 14C based on the position signal sent from the photodetector 21. Next in Step S42, the control apparatus 28 performs a process of detecting pattern bits 47 based on a signal (hereinafter, referred to as “bit detection signal) output from each photodetector 51 in response to receiving light reflected from the patterned bits 47. The bit detection signal is a clock signal as indicated by S_{R} in FIG. 22.

The patterned bits 47 in the track direction are provided at regular intervals; however, the intervals may become slightly irregular due to an error and the like. The influence of the error appears as cycle deviation of the bit detection signal S_{R}.

Next in Step S44, the control apparatus 28 calculates the amount of displacement of the head 14C from its proper position based on the position of the head 14C obtained in Step S40.

Next in Step S46, the control apparatus 28 determines whether the amount of displacement calculated in Step S44 is equal to or more than the length that the piezoelectric elements serving as the second sliders 18 are able to shift the write/read devices 19/20. If the amount of displacement of the head 14C exceeds the amount that can be shifted by the piezoelectric elements, the control apparatus 28 drives the VCM 12 to move the head 14C to its proper position.

If the amount of displacement calculated in Step S42 is less than the amount that can be shifted by the piezoelectric elements, in Step S48, the control apparatus 28 shifts the write/read devices 19/20 to their adequate positions using the second sliders 18 formed of piezoelectric elements. According to the above processes in Steps S46 and S48, the write/read devices 19/20 become aligned to the data tracks 46. As a result, in Step S50, the write/read devices 19/20 are able to favorably perform the magnetic recording/playback process on the data tracks 46.

According to the present embodiment, the photodetectors 51 are provided on the head 14C in such a manner as to correspond one-to-one with the individual data tracks 46 for the magnetic recording/playback process. On the slider 16 of the head 14C, the photodetectors 51 are provided anterior to the write devices 19 in the X direction (the relative moving direction of the head 14C). That is, the bit detection signals generated by the photodetectors 51 are detected before the write devices 19 perform magnetic recording on patterned bits 47. In addition, the distance between each photodetector 51 and its corresponding write device 19 (indicated by arrow ΔL in FIG. 21) is constant.

Accordingly, in Step S50, the control apparatus 28 generates a write signal S_{W} (see FIG. 22), which is delayed from the clock bit detection signal S_{R} transmitted from each photodetector 51 by a time corresponding to the constant distance ΔL between the photodetector 51 and the corresponding write device 19, and performs the magnetic recording process on the patterned bits 47 in sync with the write signal S_{W}.

According to the structure, even if irregularity has been introduced to the intervals of the patterned bits 47 due to an error or the like, the magnetic recording process is performed based on the write signal S_{W} generated from the bit detection signal S_{R} on which the error is superimporsed, whereby the write devices 19 are able to perform magnetic recording to the patterned bits 47 in a reliable fashion.

In the present embodiment also, as described above, the head 14C has a structure in which the photodetector 21 dedicated to follow the servo tracks 45 and the write/read devices 19/20 for performing the magnetic recording/playback process on the data tracks 46 are disposed in accordance with the track pitches. The position of the head 14C is corrected based on the intensity of the reflected light detected by the photodetector 21. As a result, even if distortion is present in the individual tracks 45 and 46, the positioning accuracy is compensated and the recording/playback process can be performed with high accuracy.

Since the servo tracks 45 are isolated from the data tracks 46, it is possible to obtain the position information of the head 14C in a continuous manner. As a result, even if high-order skew (large distortion) is present in the magnetic disc medium 30C, the track distortion can be followed with high accuracy.

In addition, regarding the off-track amount of each servo tracks 45, a pattern (a phase pattern indicated by diagonal lines in the figures) which is recorded in the servo tracks 45 is detected. Herewith, according to the amount (large or small) of reflection from the phase pattern, the off-track amount can be detected, thereby enabling further accurate positioning.

The present embodiment also has the following advantageous effects as in the case of the first embodiment: being able to compensate track pitch displacement with higher accuracy since the write/read devices 19/20 are finely adjustable in the cross track direction (Y direction) by the second sliders 18 formed of piezoelectric elements; and being able to eliminate the possibility of being magnetically influenced by adjacent tracks since the data tracks 46 are optically detected, thereby enabling positioning with high accuracy.

In conclusion, according to one embodiment of the present disclosure, the magnetic disc medium has the first part and the second part having different light reflections, and the head includes the first device for detecting reflection of the magnetic disc medium and the second device for performing magnetic recording and playback processes on the magnetic disc medium. Herewith, the second device is able to determine a position for magnetic recording/playback on the magnetic disc medium based on the reflection of the magnetic disc medium detected by the first device. As a result, even if the magnetic disc medium is distorted, it is possible to cause the head to follow the data tracks with high accuracy.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. A magnetic disc apparatus comprising:
a magnetic disc medium including a first part and a second part having light reflection different from light reflection of the first part;
a head having a first device for detecting reflectivity on the magnetic disc medium and a second device for performing magnetic recording/playback on the magnetic disc medium; and
a positioning unit configured to determine, based on the reflectivity on the magnetic disc medium detected by the first device, a position for the magnetic recording/playback performed by the second device on the magnetic disc medium.

2. The magnetic disc apparatus as claimed in claim 1, wherein the first part is a magnetic body used for the magnetic recording/playback, and the second part is a medium body of the magnetic disc medium.

3. The magnetic disc apparatus as claimed in claim 2, wherein the first part includes a data track and a servo track, and the first device detects reflectivity of the servo track.

4. The magnetic disc apparatus as claimed in claim 3, wherein the first device includes a light emitting device configured to emit light having a spot diameter equal to a track width of the servo track and a light receiving device configured to receive light reflected from the servo track.

5. The magnetic disc apparatus as claimed in claim 3, wherein the second device includes a recording device configured to perform the magnetic recording on the data track and a playback device configured to perform the magnetic playback of information recorded in the data track, and the recording device and the playback device are disposed on a driven device which is driven by the positioning unit.

6. The magnetic disc apparatus as claimed in claim 2, wherein the first part includes a data track and a servo sector, the first device detects reflectivity of the data track, the second device reads servo information from the servo sector, and the positioning unit determines the position for the magnetic recording/playback based on a result of the detection of the first device and a result of the reading of the second device.

7. The magnetic disc apparatus as claimed in claim 6, wherein the first device includes a light emitting device configured to emit light having a spot diameter equal to a track width of the data track and a light receiving device configured to receive light reflected from the data track.

8. The magnetic disc apparatus as claimed in claim 6, wherein the second device includes a recording device configured to perform the magnetic recording on the data track and a playback device configured to perform the magnetic playback of information recorded in the data track and the servo sector, and the recording device and the playback device are disposed on a driven device which is driven by the positioning unit.

9. The magnetic disc apparatus as claimed in claim 2, wherein the first part includes a servo track and a data track in which a plurality of patterned bits are aligned in a track direction, and the first device detects reflectivity of the servo track.

10. The magnetic disc apparatus as claimed in claim 9, wherein the first device includes a light emitting device configured to emit light having a spot diameter equal to a track width of the servo track and a light receiving device configured to receive light reflected from the servo track.

11. The magnetic disc apparatus as claimed in claim 9, wherein the second device includes a recording device configured to perform the magnetic recording on the data track and a playback device configured to perform the magnetic playback of information recorded in the data track, and the recording device and the playback device are disposed on a driven device which is driven by the positioning unit.

12. The magnetic disc apparatus as claimed in claim 9, wherein the head further has a third device identical to the first device, disposed in such a manner as to correspond to the data track, and configured to detect reflectivity of the patterned bits, and the positioning unit determines the position for the magnetic recording/playback based on the reflectivity of the patterned bits detected by the third device.

13. A magnetic disc medium including a first part and a second part having light reflection different from light reflection of the first part, wherein the first part is formed of a magnetic body, and the second part is a part at which a medium body of the magnetic disc medium is exposed.

14. The magnetic disc medium as claimed in claim 13, wherein the first part includes a data track and a servo track.

15. The magnetic disc medium as claimed in claim 13, wherein the first part includes a data track and a servo sector.

16. The magnetic disc medium as claimed in claim 13, wherein the first part includes a servo track and a data track in which a plurality of patterned bits are aligned in a track direction.

17. A head for performing magnetic recording/playback on a magnetic disc medium including a first part at which a magnetic body used for the magnetic recording/playback is disposed and a second part having light reflection different from light reflection of the first part, the head comprising:
a first device configured to detect reflectivity on the magnetic disc medium; and
a second device configured to perform the magnetic recording/playback on the magnetic disc medium;
wherein the first device and the second device are disposed on a slider.

18. The head as claimed in claim 17, wherein the second device includes a recording device configured to perform the magnetic recording on the data track and a playback device configured to perform the magnetic playback of information recorded in the data track, and the recording device and the playback device are disposed on a driven device so as to be positionally shifted by the driven device.

19. A track following method applied to a magnetic disc apparatus that includes a magnetic disc medium having a first part and a second part having light reflection different from light reflection of the first part, a head having a first device for detecting reflectivity on the magnetic disc medium and a second device for performing magnetic recording/playback on the magnetic disc medium, and a moving unit configured to move the head, the track following method causing the second device to follow a data track included in the first part, and comprising:
(a) detecting the reflectivity on the magnetic disc medium using the first device;
(b) calculating displacement of the second device from the data track based on the detected reflectivity; and
(c) moving the head using the moving unit so as to correct the calculated displacement.

20. The track following method as claimed in claim 19, wherein the first part also includes a servo track, and reflectivity of the servo track is detected by the first device in (a).

21. The track following method as claimed in claim 19, wherein the first part also includes a servo sector, the first device detects reflectivity of the data track and the second device reads servo information from the servo sector in (a), and the displacement of the second device from the data track is calculated based on the detected reflectivity and the servo information in (b).
